(19) United States
(12) Patent Application Publication
(10) Pub. No.: US 2009/0208814 A1
(43) Pub. Date: Aug. 20, 2009

(54) HONEYCOMB-TYPE SOLID OXIDE FUEL CELL AND METHOD FOR MANUFACTURING THE SAME

(75) Inventors: Sung Pil Yoon, Gyeonggi-do (KR); Tae Hoon Lim, Seoul (KR); Suk-woo Nam, Seoul (KR); Heung Yong Ha, Seoul (KR); Jonghee Han, Seoul (KR); Hyoung-Juhn Kim, Gyeonggi-do (KR); Eun Ae Cho, Seoul (KR); Jaeyoung Lee, Incheon (KR); Hyung Chul Hahm, Seoul (KR)

Correspondence Address: MERCHANT & GOULD PC, P.O. BOX 2903, MINNEAPOLIS, MN, 55402-0903, US

(73) Assignee: Korea Institute of Science & Technology, Seoul (KR)

(21) Appl. No.: 12/296,632

(22) PCT Filed: Dec. 11, 2006
(86) PCT No.: PCT/KR2006/005383

§ 371 Date: Apr. 16, 2009

(30) Foreign Application Priority Data
Apr. 10, 2006 (KR) 10-2006-0032365

(51) Int. Cl. H01M 4/48; H01M 8/10; H01M 4/38; C04B 35/01

(52) U.S. Cl. 429/44; 429/40; 264/104

(57) ABSTRACT

The present invention relates to a honeycomb type SOFC wherein a first material, density of which is lowered upon phase-transition, a second material having higher thermal expansion coefficient than that of an electrode supporter, or a composite material of the first and second materials is filled in the electrode channel to which the collector is bonded as a material which can form an oxide under the electrode atmosphere, and a manufacturing method thereof.

### TECHNICAL FIELD

The present invention relates to a honeycomb type solid oxide fuel cell (SOFC) and a manufacturing method thereof, and more particularly to a honeycomb type SOFC and a manufacturing method thereof wherein a problem that upon the current collection in the unit cells of the SOFC or a stack thereof, the current collection is not easy and the collection resistance is relatively large because a junction between a collector and an electrode is carried out in a channel is resolved.

### BACKGROUND ART

Generally, a solid oxide fuel cell (SOFC) is classified into a cylindrical type and a planar type according to a shape of a unit cell thereof.

The cylindrical type SOFC has problems that it requires a high cost process such as electrochemical vapor deposition (EVD) instead of no need of gas sealing and internal resistance is large due to a far collection distance between electrodes. Further, it has problems that high output density is hardly obtained in comparison with the planar type SOFC due to its far distance between a reaction position and a collector.

To the contrary, the planar type SOFC has an advantage that manufacturing cost is low and a collection distance is short by means of using a wet process. However, it has a problem of large internal resistance of a stack due to an inconstancy in thickness between unit cells as well as difficulty in gas sealing.

Thus, diverse SOFC unit cells and stack structures resolving the problems of the cylindrical or planar type SOFC and realizing performance improvement and compact size thereof has been developed.

A representative example thereof is an anode supported type SOFC or a honeycomb type SOFC in which an electrolyte can be made thinner below 10 μm. The anode supported type SOFC is a unit cell structure in which a thin film electrolyte of 10 μm or less is formed by using porous NiO and YSZ cermet as a support. Unit cells have been recently reported to have high performance of 1 W/cm² or more <S. D. Souza, S. J. Visco, and L. C. De Jonghe, Thin-Film Solid Oxide Fuel Cell with High performance at Low-Temperature, Solid State Ionics, 98, p. 57-61, 1997>. However, they have problems of occurrence of mechanical stress due to the difference in thermal expansion coefficient from a metal separator, degradation in electrical conductivity due to oxidation of the metal separator, and reduction in cell stability due to a change in structure resulting from oxidation-reduction of an anode during a heat cycle.

Meanwhile, the honeycomb type SOFC is configured so that a reaction area of a cell is enlarged, thereby improving output density per unit volume. It has an structural advantage of higher thermal impact resistance than that of the planar type SOFC. However, compared to the planar type SOFC, in the honeycomb type SOFC, a junction between an electrode and a collector should be done in a channel of a honeycomb structure so that the current collection is not easy and a problem of having relative large collection resistance is caused.

Meanwhile, it is common that in the honeycomb type SOFC, the collector (typically mesh-shaped) is used in its channel, but it is difficult to apply a mechanical force such as surface pressure, which is required for current collection, from outside so that the collector is not properly attached to the electrode, which makes the current collection difficult.

For solving those problems, paste composed of noble metal material such as Au, Ag, Pt, etc. has been applied a lot onto the surface of the electrode so as to reduce the current collection resistance.

However, in spite of such effort, the conventional collection method of the honeycomb type SOFC does not satisfy the characteristics required for commercialization of the SOFC. Further, an improved honeycomb type SOFC capable of the efficient current collection and a manufacturing method thereof have not been developed yet.

### DISCLOSURE

### Technical Problem

The present invention has been made to solve the above-mentioned problems, and an object of the present invention is to provide a honeycomb type SOFC capable of the efficient and easy current collection and a manufacturing method thereof. As well, the other object of the present invention is to provide a honeycomb type SOFC wherein air and fuel gas can flow in a good manner in its channel and a manufacturing method thereof.

### Technical Solution

According to the present invention, in order to solve the problems, there is provided a honeycomb type SOFC comprising an electrode channel and a collector bonded to the electrode, wherein a first material, density of which is lowered upon phase-transition, a second material having higher thermal expansion coefficient than that of an electrode supporter, or a composite material of the first and second materials is filled in the electrode channel to which the collector is bonded as a material which can form an oxide under the electrode atmosphere.

Further, according to the present invention, in order to solve the problems, there is provided a method of manufacturing a honeycomb type SOFC comprising an electrode channel and a collector bonded to an electrode, the method comprising a step of filling a first material, density of which is lowered upon phase-transition, a second material having higher thermal expansion coefficient than that of an electrode supporter, or a composite material of the first and second materials in the electrode channel as a material which can form an oxide under the electrode atmosphere.

In a preferable embodyment of the invention, the first or second material is granular powders having a type of a sphere, a chain, or a whisker.

In a preferable embodyment of the invention, the first or second material is mixed with a pore-formation agent and the mixed materials are filled in the electrode channel.

In a preferable embodyment of the invention, the first material is a metal, density of which is lowered upon the formation of an oxide.

In a preferable embodyment of the invention, the first material is one or more metals selected from a group consisting of Cr, Fe, Co, Ni, Cu and Zn.

In a preferable embodyment of the invention, the second material is one or more metal oxides selected from a group consisting of NiO, Fe₂O₃, CoO, CuO, ZnO if the electrode supporter is made of yttria-stabilized zirconia (YSZ).

In a preferable embodyment of the invention, if the material of the electrode supporter is the composite material of NiO and YSZ or ceria, the second material is one or more metals or oxides selected from a group consisting of Pt; Ag; Au; Rh; Ir; Pd; Ru; (La_{1-X}Sr_{X})MnO₃ where X is 0.5 or less; (La_{1-X}Car_{X})MnO₃ where X is 0.5 or less; (La_{1-X}Sr_{X})CoO₃ where X is 0.6 or less; and (La_{1-X}Sr_{X})(Co_{1-y}Fe_{y})O₃ where X is 0.4 or less and y is 0.8 or less.

In a preferable embodyment of the invention, the second material is vermiculate which is a thermally expandable ceramic.

In a preferable embodyment of the invention, the collector is made of metal, and more preferably is made of Pt, Ag, Au, Ni, or Cu, or an alloy thereof.

### Advantageous Effects

According to the present invention, a current collector is bonded to an electrode in an electrode channel of the honeycomb type SOFC with sufficient physical force using a material characteristic such as phase transition or thermal expansion coefficient difference of porous filler materials, thereby efficiently implementing the current collection. Further, the present invention has an advantage of providing a passage through which fuel and air gas are smoothly diffused toward the fuel cell electrode by securing porosity.

### DESCRIPTION OF DRAWINGS

FIG. 1 is a photograph showing the honeycomb type SOFC according to a first example of the invention.

FIG. 2 is a graph showing an impedance analysis results for the respective cases where vermiculate is and is not filled in the channel according to the second example of the invention.

### MODE FOR INVENTION

Hereinafter, a honeycomb type SOFC and a manufacturing method thereof according to the present invention will be described in detail.

According to the present invention, in order to facilitate the current collection in a cathode and an anode existed in a channel in the honeycomb type SOFC unit cell and stack thereof, a filler material is filled around a collector to be bonded to an electrode. The electrode and the collector in the honeycomb type SOFC channel can be strongly and easily bonded to each other, which makes the efficient and easy current collection possible, under the working temperature of the honeycomb type SOFC by means of using material characteristic such as the density change of the filler material or the thermal expansion coefficient difference between the filler material and the honeycomb type SOFC framework material, i.e., an electrode support material, which occur when the filler material is phase-transited by a change in an external condition such as a temperature or a partial pressure. Further, according to the present invention, air and fuel gas can flow smoothly in the respective channels of the unit cell and the stack structure.

For manufacturing a unit cell of the honeycomb type SOFC, a collector is bonded to a surface of an electrode in the electrode channel of the honeycomb type SOFC using an organic binder. Herein, a mesh type collector can be used. The collector is composed of preferably metal, more preferably Pt, Ag, Au, Ni, or Cu or an alloy thereof in terms of the current collection efficiency. Meanwhile, the organic binder is preferably a polymeric binder, which is easily removable by heat treatment.

Next, the filler material is loaded in the electrode channel to which the collector is bonded. The filler material is a material that can form oxide in each electrode atmosphere. The filler material may be a material (first material), a density of which is lowered upon its phase-transition (i.e., before and after its phase-transition), a material (second material) having higher thermal expansion coefficient than that of the electrode support material which is the honeycomb type SOFC framework material, or a composite material of the first and second materials.

Specifically, the first material is a material which can form an oxide in the respective electrode atmospheres, preferably a metal whose density is lowered upon the oxide forming.

More preferably, the first material is one or more metals selected from a group consisting of Cr, Fe, Co, Ni, Cu, and Zn. If cheaper metal such as Fe is selected, cost-effective, simple, efficient current collection can be implemented.

Regarding the first material, in case of the anode of the honeycomb type SOFC, it is possible that the filler material does not exist as an oxide according to fuel to be used, i.e., oxygen partial pressure of the fuel at a measuring temperature. For example, in case that pure hydrogen is used as fuel at 700° C., Fe, Ni and the like among the first material do not exist as an oxide. Therefore, according to the present invention, in case of selecting the filler material, a material which can form an oxide according to the anode atmosphere (even under high reduction atmosphere) is selected as the filler material. Of course, the cathode is always under the oxidation atmosphere so that an oxide can be formed.

If a material of the electrode supporter is yttria-stabilized zirconia (YSZ), the second material is preferably at least one metal oxide selected from a group consisting of NiO, Fe₂O₃, CoO, CuO, ZnO and the like, which have higher thermal expansion coefficient than that of the YSZ.

Meanwhile, if the material of the electrode supporter is the composite material of NiO and YSZ, or the composite material of NiO or ceria, the second material is at least one metal or oxide selected from a group consisting of Pt, Ag, Au, Rh, Ir, Pd and Ru, (La_{1-X}Sr_{X})MnO₃ where X is 0.5 or less, (La_{1-X}Car_{X})MnO₃ where X is 0.5 or less, (La_{1-X}Sr_{X})CoO₃ where X is 0.6 or less, and (La_{1-X}Sr_{X})(Co_{1-y}Fe_{y})O₃ where X is 0.4 or less and y is 0.8 or less, which are higher thermal expansion coefficient than that of the composite material.

Further, preferably, the second material is thermally expandable ceramics such as vemiculate, which has vey high thermal expansion coefficient.

Meanwhile, according to the present invention, granular powders having a form of a sphere, a chain, or a whisker which are easy to secure porosity is particularly used as the filler material in order to easily obtain porosity. Further, if the pore-formation agent like graphite is filled together with the filler material, the porosity can be further easily increased by increasing the pore ratio. By obtaining the porosity, smooth gas diffusion is induced so that air and fuel gas can smoothly flow in the electrode channel.

Next, the honeycomb type SOFC is heat-treated to a proper temperature so that the pore-formation agent and the organic binder, which has been used in junction between the electrode and the collector, are removed.

According to the present invention, the efficient and easy current collection can be performed through the strong and easy physical junction between the electrode and the collector in the channel, which is obtained by means of inducing the phase-transition in the filler material according to a change in external condition accompanied by the heat-treatment to a desired temperature or partial pressure regulation and thereby using the density change of the filler material upon the phase-transition, or by means of using the difference in thermal expansion coefficient between the electrode supporter material and the filler material.

In manufacturing a stack, a metal mesh suitable to a size of a channel or between the channels, for example, Pt, Au, Ni, or Ag mesh, is used to implement the current collection.

As described above, according to the the present invention, the electrode channel of the honeycomb type SOFC is filled with a material, which is lowered in its density upon phase-transition, or has higher thermal expansion coefficient than that of the electrode supporter of the honeycomb type SOFC, so as to solve the problems of the conventional honeycomb type SOFC, thereby implementing the current collection efficiently and easily.

### EXAMPLE 1

A Pt mesh to be used as a collector was positioned on an electrode in a channel of a honeycomb type SOFC structure, and the electrode and the collector were bonded to each other using a spray adhesive (75 spray adhesive from 3M corp.).

Next, Fe powders (grain size of 20 μm) and graphite powders of a pore-formation agent were mixed with each other in a volume ratio of 70% of Fe powders to 30% of graphite powders to form mixed powers, which were filled in the electrode channel to which the collector was bonded. The pressure were applied, thereby fixing the Pt mesh in the channel.

Next, heat-treatment was done at 300° C. for 2 hours to remove the adhesive, and heat-treatment was then carried out at 900° C. for 4 hours so as to remove the graphite powders of the pore-formation agent.

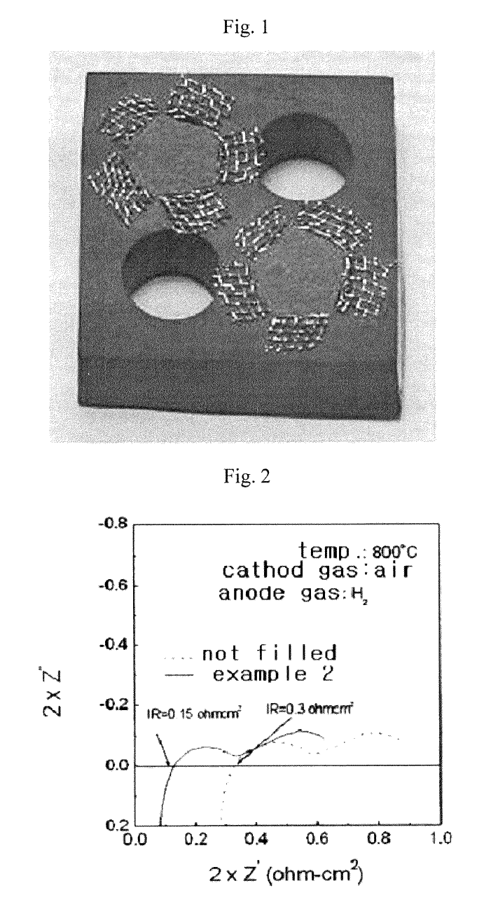

Herein, Fe powders added at 700° C. or more were phase-transited into iron oxides so that the density change (volume change) occurred in the process of the phase-transition of Fe powder (9.08 g/cm³) into Hematite (Fe₂O₃) (5.27 g/cm³), thereby increasing adhesion force between the electrode and the collector and therefore improving the current collection performance. FIG. 1 is a photograph showing the honeycomb type SOFC according to a first example of the invention.

### EXAMPLE 2

A collector was bonded to an electrode in an electrode channel of a honeycomb type SOFC structure using the same method as that of the first embodiment. As an electrode supporter, a conventional Ni/YSZ powers was used. As a collector, a Pt mesh was used.

Next, vermiculate powders which are thermally expandable ceramics were filled around the collector in the channel. The ceramic powders were expanded upon being heated. To this end, the adhesion force between the collector and the electrode was increased and thus the current collection performance was increased.

FIG. 2 is a graph showing an impedance analysis results for the respective cases where vermiculate is and is not filled in the channel according to the second example of the invention.

As shown from FIG. 2, the impedance analysis shows that in case of filling vermiculate in the channel according to this example, internal resistance (IR) was reduced by half amount from 0.3 Ωcm² to 0.15 Ωcm² when hydrogen was used as fuel and air was used as an oxidizer at 800° C.

### INDUSTRIAL APPLICABILITY

The present invention relates to a new honeycomb type SOFC and a manufacturing method thereof, wherein it is possible to resolve the problems that the current collecting resistance is relatively high since the junction between the current collector and electrode is carried out in the channel of SOFC unit cell or its stack and therefore the current collection is difficult.

1. A honeycomb type SOFC comprising an electrode channel and a collector bonded to the electrode,
wherein a first material, density of which is lowered upon phase-transition, a second material having higher thermal expansion coefficient than that of an electrode supporter, or a composite material of the first and second materials is filled in the electrode channel to which the collector is bonded as a material which can form an oxide under the electrode atmosphere.

2. The honeycomb type SOFC according to claim 1, wherein the first or second material is granular powders having a type of a sphere, a chain, or a whisker.

3. The honeycomb type SOFC according to claim 1, wherein the first or second material is mixed with a pore-formation agent and the mixed materials are filled in the electrode channel.

4. The honeycomb type SOFC according to claim 1, wherein the first material is a metal, density of which is lowered upon the formation of an oxide.

5. The honeycomb type SOFC according to claim 1, wherein the first material is one or more metals selected from a group consisting of Cr, Fe, Co, Ni, Cu and Zn.

6. The honeycomb type SOFC according to claim 1, wherein the second material is one or more metal oxides selected from a group consisting of NiO, Fe₂O₃, CoO, CuO, ZnO if the electrode supporter is made of yttria-stabilized zirconia (YSZ).

7. The honeycomb type SOFC according to claim 1, wherein if the material of the electrode supporter is the composite material of NiO and YSZ or ceria, the second material is one or more metals or oxides selected from a group consisting of Pt; Ag; Au; Rh; Ir; Pd; Ru; (La_{1-X}Sr_{X})MnO₃ where X is 0.5 or less; (La_{1-X}Car_{X})MnO₃ where X is 0.5 or less; (La_{1-X}Sr_{X})CoO₃ where X is 0.6 or less; and (La_{1-X}Sr_{X})(Co_{1-y}Fe_{y})O₃ where X is 0.4 or less and y is 0.8 or less.

8. The honeycomb type SOFC according to claim 1, wherein the second material is vermiculate which is a thermally expandable ceramic.

9. The honeycomb type SOFC according to claim 1, wherein the collector is made of Pt, Ag, Au, Ni, or Cu, or an alloy thereof.

10. A method of manufacturing a honeycomb type SOFC comprising an electrode channel and a collector bonded to an electrode,
the method comprising a step of filling a first material, density of which is lowered upon phase-transition, a second material having higher thermal expansion coefficient than that of an electrode supporter, or a composite material of the first and second materials in the electrode channel as a material which can form an oxide under the electrode atmosphere.

11. The method according to claim 10, wherein the first or second material is formed with granular powders having a type of a sphere, a chain, or a whisker.

12. The method according to claim 10, wherein the first or second material is mixed with a pore-formation agent and the mixed materials are filled in the electrode channel.

13. The method according to claim 10, wherein a metal, density of which is lowered upon the formation of an oxide, is used as the first material.

14. The method according to claim 10, wherein one or more metals selected from a group consisting of Cr, Fe, Co, Ni, Cu, and Zn is used as the first material.

15. The method according to claim 10, wherein one or more metal oxides selected from a group consisting of NiO, Fe₂O₃, CoO, CuO, ZnO is used as the second material if the electrode supporter is made of yttria-stabilized zirconia (YSZ).

16. The method according to claim 10, wherein if the material of the electrode supporter is the composite material of NiO and YSZ or ceria, one or more metals or oxides selected from a group consisting of Pt; Ag; Au; Rh; Ir; Pd; Ru; (La_{1-X}Sr_{X})MnO₃ where X is 0.5 or less; (La_{1-X}Car_{X})MnO₃ where X is 0.5 or less; (La_{1-X}Sr_{X})CoO₃ where X is 0.6 or less; and (La_{1-X}Sr_{X})(Co_{1-y}Fe_{y})O₃ where X is 0.4 or less and y is 0.8 or less is used as the second material.

17. The method according to claim 10, wherein a vermiculate which is a thermally expandable ceramic is used as the second material.

18. The method according to claim 10, wherein Pt, Ag, Au, Ni, or Cu, or an alloy thereof is used as the collector.
